(19) United States
(12) Patent Application Publication
(10) Pub. No.: US 2014/0310200 A1
(43) Pub. Date: Oct. 16, 2014

(54) Social Investing Network (SIN) that uses mobile communication devices or personal computers to conduct business investments and social connectivity for the Crowd Funding Industry from within a single Network configuration by means of CrowdBoarding

(71) Applicants: Martin Lewis Kelman, McKinney, TX (US); Daniel Lewis Kelman, McKinney, TX (US)

(72) Inventors: Martin Lewis Kelman, McKinney, TX (US); Daniel Lewis Kelman, McKinney, TX (US)

(21) Appl. No.: 13/972,945

(22) Filed: Aug. 22, 2013

(51) Int. Cl. G06Q 50/00

(52) U.S. Cl. CPC G06Q 50/01; G06Q 40/06
USPC 705/36 R

(57) ABSTRACT

A Social Investing Network (SIN) that uses mobile communication devices or personal computers to conduct business investments and social connectivity for the Crowd Funding Industry from within a single Network configuration. Social Investing is achieved by the use of CrowdBoards and Fixed Target Variable Level Crowdfunding (FTVLC) methodology. The SIN eliminates the need for Crowd Boarders to access and log into multiple sites to carry out these tasks and also offers tiered individual profiles for different users determined by user group selection and specific tasks administered within the Network. The social activities that take place and the title of these actions in pursuit of different CrowdBoards is herein referred to as “CrowdBoarding”.

### CROSS REFERENCE TO RELATED APPLICATIONS

This application claims the benefit of priority of U.S. Provisional patent No. 61/704,881, filed Sep. 24, 2012, which is herein incorporated by reference.

### FIELD OF THE INVENTION

This present invention relates to the field of social investing, incorporating social interaction, business investments, social media communication networks, applications, design and method of use.

### BACKGROUND

The CrowdFunding specific legislation enactment of the Jumpstart Our Business Startups Act (JOBS Act) by the United States Congress has afforded Crowdfunding Platforms the opportunity to now raise finance for small businesses within mandatory guidelines to be set by the Securities and Exchange Commission in the near future. The initial guidelines include an exemption (Regulation D) to the Securities Act of 1933 which relates to the sale of company securities and the general methodology used to seek Investor participation. Without the necessity for the long standing in depth filing requirements for pre-determined levels of financial investment, many of the Crowdfunding platforms are now actively seeking participation via specific Internet sites designed to attract and process transaction from investors. These platforms offer the following 4 types of distinct opportunity for the Investor, Equity, Rewards, Lending and Donations.

CrowdFunding opportunities are offered to a large group of people (“collectively the Crowd”) with the intention of seeking group interaction and later participation, which results in them make financial investments with an expected advertised return or reward for carrying out this activity.

A CrowdBoarder therefore can actively search and advertise for crowd funded contributions on a Social Investing Network from an online group consisting of a combination of accredited and non-accredited Investors. This type of financial aid request has traditionally commonly been referred to and labeled with the financial industries generalist terms such as “a pledge, a campaign, a project, and a raise” until now when the term “CrowdBoard” is being introduced which is both specific to the industry and specific for the methodology used in practice to raise the necessary funds via an online portal referred to as a Social Investing Network.

Accordingly, by way of example, the present invention will be described by reference to a Social Investing Network in that it doesn't limit the CrowdBoarder to a set group of friends and fellow Boarders, but instead allow the social interaction to be on a global scale and focus on common goals to share ideas, create Crowd Boards, actively participate in a wide range of CrowdBoard features and predominately seek funding for their relevant Board either individually or collectively.

Building on the Social Investing Network, Boarders can create CrowdBoards which can be used for Investments, pledges or donations for ideas that they have a passion for, believe in, or a desire to make a difference with, this can be offered accordingly to all the different types of Boarders, fellow CrowdBoarders, Brokers, Platform Owners and Industry Organizations for their social investing Involvement.

The standard Crowdfunding execution methodology that exists today is to offer an opportunity for a fixed time duration for a Target Fund amount while actively encourage oversubscription of the opportunity with the intent to try to increase the Crowdfunding platform's potential revenue stream within the dedicated timeframe. If opportunities are poorly subscribed to and funded then they are still closed down at the end of the dedicated timeframe or on occasion earlier if the likelihood of success becomes clearly apparent as non-existent.

A substantial majority of individuals more than 50% have difficulty in raising the required set finance need for their posted opportunity within a pre-determined timeframe as required by existing Crowdfunding Platforms operating on fixed time duration terms and therefore the opportunity is deemed unsuccessful due to a subsequent failure to raise the funds.

Accordingly, there exists a need for a method which will allow individuals, for example, to raise capital via Crowdfunding for producing a creative work where variable financial levels of investment are offered so that the set target amount of funding can be achieved independent of a fixed time duration of offer.

To that end, it would be ideal to develop a new methodology to actively encourage Crowd Boarders to make timely and firm investments in Crowd Boards once created, that are neither set up to accept overfunding or to remain open for fixed time durations as currently exists today in order to positively increase the likelihood of full funding success.

Accordingly, by way of example, the present invention will be described by reference to a methodology for raising the desired funds with a fixed financial target and without fixed time duration. This methodology is termed Fixed Target Variable Level Crowdfunding (FTVLC) wherein the CrowdBoard owner chooses the fixed level of funding required and the 3 (three) distinct levels of desired Investments to be offered in order to reach their set target of funding. In a time period that is totally dependent on the future historical levels of investments to determine the actual time taken to reach and achieve the specific CrowdBoard Fixed Financial Target (FTT).

### BRIEF SUMMARY OF THE INVENTION

A Social investing Network (SIN) specifically set up for CrowdBoarders which provides a single point user access to perform a wide range of social interactions and investments into CrowdBoards of their determination. A SIN comprises a social interaction application tool with a communication facility, a dialog component, at least one social Internet link available, a tile display, a customized database containing an interaction component, wherein the social interaction tool is stored on, accessed and executed from a portable media storage device, desk top computer, laptop computer, tablet computer, hand held device, mobile phone or a combination thereof.

In one aspect of the present invention, is a method and application for creating, displaying, monitoring and completion of funding for a crowdfunding opportunity by means of a CrowdBoard. Which is defined as a “purpose built” internet board created and displayed by the individual, seeking public involvement and investment via a Social Network, in order to fulfill their goal, ambition, creation or destiny. The CrowdBoard consists of user input data, graphical presentations of CrowdBoard details and performance and output of standard statistics for Crowd Boarder evaluation and regulatory compliance.

The present invention is also directed to a system and methodology for an individual or group to raise funds via a Crowdfunding platform for an opportunity with variable terms of participation by means of Fixed Target Variable Level Crowdfunding (FTVLC) where the opportunity may be any form of financial opportunity which is for a fixed amount to be raised without a fixed time of participation. The method including variance of the participation of at least one or more CrowdBoards by offering variable levels of participants, pledges, investments or memberships at pre-determined amounts which directly vary the time period associated with reaching the fixed amount of finance by the permutation of the variable transactions conducted accordingly. This variance will be directly related to and subsequently change the number of minimum or maximum transactions necessary to attain the fixed amount of finance required. This may involve registration by the Crowd Boarder onto a centralized database, of at least one or more CrowdBoards, offering an entitlement related to the Board in exchange for capital for the Board owner. The method and system may also include searching, by an interested party, the centralized database, for at least one Board, registering, by the interested party, with the centralized database and accepting the offer by the crowd funding company for the entitlement related to the Board owner. The capital may then be forwarded to the Board owner and the entitlement provided to the interested party. This Fixed Target Variable Level Crowdfunding (FTVLC) may be presented graphically or in written number format on the Crowd Funding website as a CrowdBoard or similar representation.

### BRIEF DESCRIPTION OF THE DRAWINGS

FIGS. 1A and 1B are connected diagrams showing the individuals social capabilities on a global basis from within the Social Investing Network utilizing My Console. In addition the Network topology of the user groups with identification and definition within the Social Investing Network according to an embodiment of the present invention.

FIGS. 2A and 2B are connected as a flow chart 2A showing the method and criteria for creating and displaying a CrowdBoard live on the Social Investing Network (SIN) and 2B which shows the graphical presentation of a live CrowdBoard and the display information contained within.

FIG. 3A shows the creation requirements for the implementation of Fixed Target Variable Level Crowdfunding (FTVLC) and the subsequent mathematical equations, values and description of values involved in the calculation requirements undertaken in order to define, support and monitor Fixed Target Variable Level Crowdfunding (FTVLC) according to an embodiment of the present invention.

### DETAILED DESCRIPTION OF THE INVENTION

The following detailed description is based on the explanations of the application and methodology in accordance with the embodiments in the invention of a Social Investing Network. The description is not to be taken as a limiting factor, but is made merely for the purpose of illustrating the guiding principles of this invention, since the scope of the invention is best defined by the appended claims enclosed herein.

An embodiment of the v don, to be used by and for CrowdBoarders, will now be described.

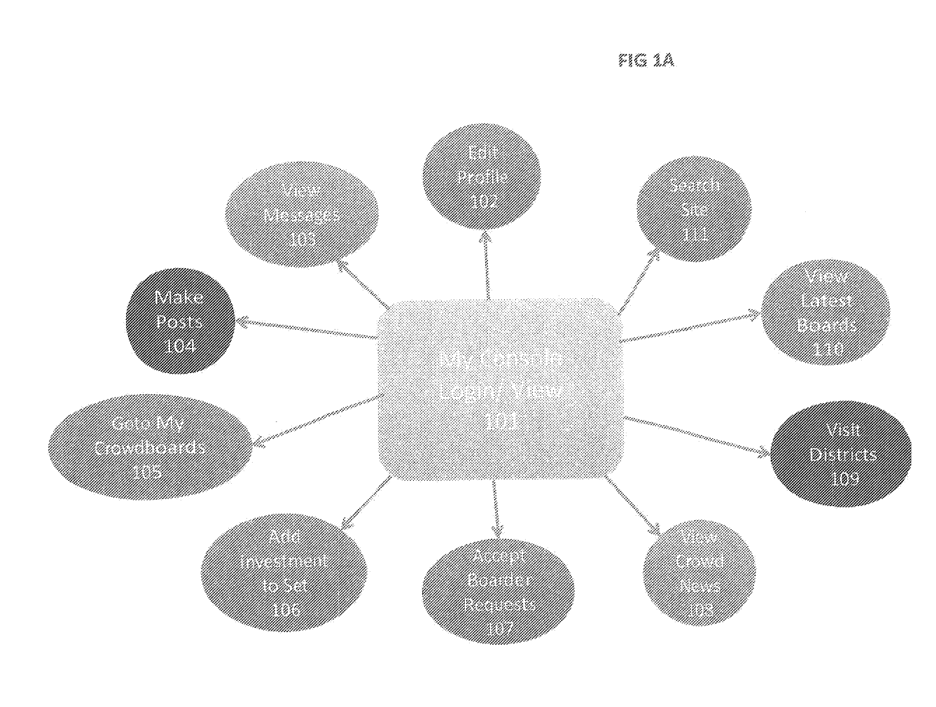

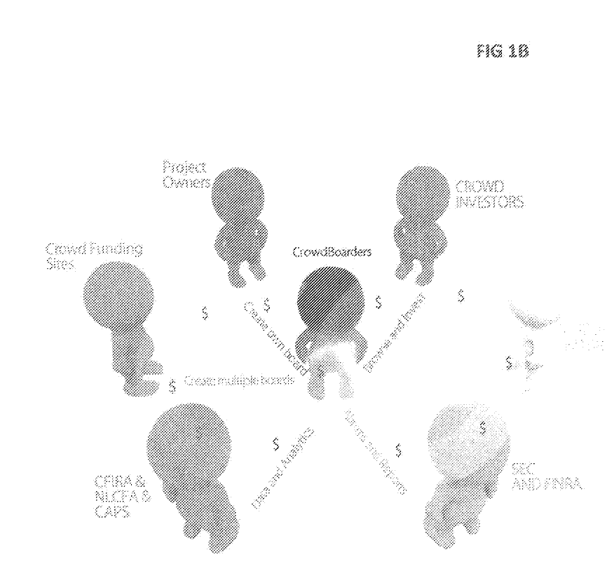

Referring to FIG. 1A, the overview of the topology of the Social Investing Network as it presents itself to the CrowdBoarder on entry into the Network by submitting a previously created username and password. The CrowdBoarder arrives at the Homepage entitled My Console as shown in Step 101. On arrival the CrowdBoarder is presented depending on their specific user group classification with their own Console incorporating a set of Social Investing activities herein further defined that then can be carried out by the individual to enhance both their individual profile to other CrowdBoarders and also their own personal Network User Experience.

Furthermore in Step 101, the CrowdBoarder can view their own Profile exactly how it would appear to a 3^{rd} Party when viewed as a Boarder Profile accessed via the Search Engine contained within the Social Investing Network. This profile contains their personal details derived from their own Profile created entries, also a summary of the viewed CrowdBoarders latest Network activity sized according to the level of content and finally a group of quick links to the CrowdBoarders Network personalization including viewing their Boarders Lineup, CrowdBoards, Districts, Possessions, Investment, Photos and Video.

Lastly in Step 101 the viewing CrowdBoarder is presented with the opportunity to either add the viewed CrowdBoarder to their own Boarder list or send an internal Network contained Message to the viewed CrowdBoarder or both if so determined dependent on their desired Social Interaction,

Referring again to FIG. 1A, in Step 102 Edit Profile the CrowdBoarder moves to an editing enabled page where they then can customize their own display Profile for the following fields: Their Username, First Name, Last Name, Profession, Resides In, Hometown, Birthday, Website and Skills. They can also further customize with their own information pertaining to their own characteristics for the following fields: About Me, My Passions are and My Dream is. They can also upload their picture and a personalized background in either Tile or Stretch mode.

Lastly in Step 102 the CrowdBoarder can personalize their own attributes to display on their Profile and for other Boarders to view for the following features: My Possessions, Boarders Lineup, My Boards and Investment Set. When all personalization is complete the Boarder can then return to their Console to verify the changes have taken place as required and are now been displayed on their Profile.

Referring again to FIG. 1A, in Step 103, View Messages the CrowdBoarder moves to an active page, where they can view their current waiting messages displayed in red numerical value at the top of the page, and furthermore socially interact with the message originator, this message interaction will be present in the center of the page, with dialogue clouds with message content and an arched arrow from the cloud pointing in the direction of the originator of the conversation item and include a date/time stamp.

Furthermore in Step 103, the CrowdBoarder can also from the view message page, access and use the following messaging features and enhancements as needed. Delete message, Forward message, Add file, Add photo and Reply to current displayed messages.

Referring again to FIG. 1A, in Step 104, the CrowdBoarder can also make their own posts either to their own activity panel which can be seen only by other CrowdBoarders viewing their specific profile or o the whole shared Network located in CrowdNews for all CrowdBoarders to see.

Furthermore in Step 104, the range of post activities that the CrowdBoarder can use are currently the following but not limited to: created CrowdBoard, update on CrowdBoard, watch CrowdBoard, share CrowdBoard, like CrowdBoard, comment on CrowdBoard, rate CrowdBoard and invested in CrowdBoard.

Referring again to FIG. 1A, in Step 105, the CrowdBoarder can access directly to the page that displays all of their personal Crowd Boarders, via the GoTo my CrowdBoards feature, this view provides them internal information about the CrowdBoard and its current status and performance, including the following but not limited to: CrowdBoard specific details, current set levels of investment with the option to make changes to the levels at any time and also based on reaching a specified % completed of funding target, daily activity of all types of posts such as number of watches, raring levels, comments and a comparison change based on the previous day's activity. The ability to update, change and add new images, video and content with the additional feature to embed the Board onto external sites at the CrowdBoard owners discretion.

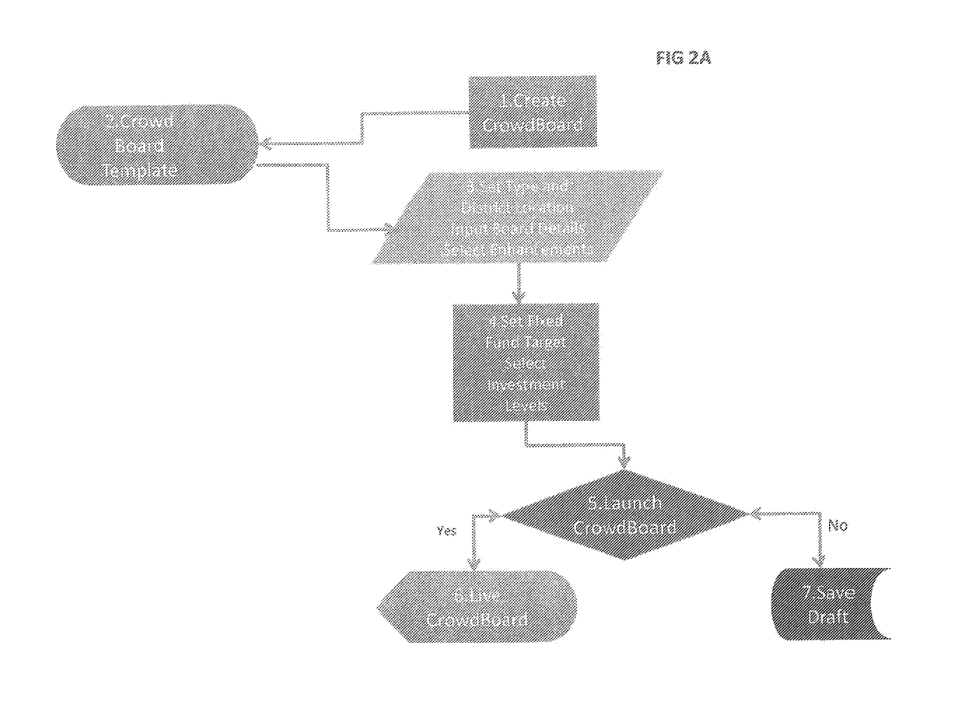

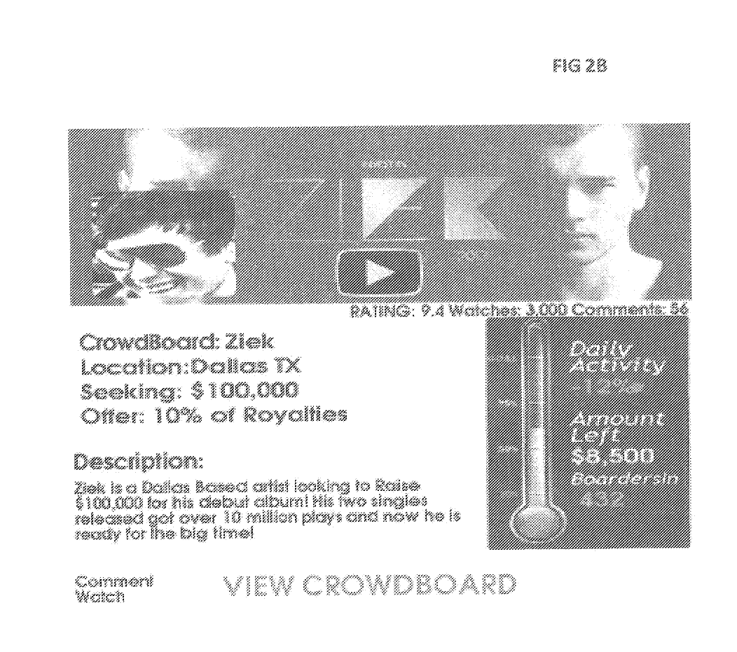

Furthermore in Step 105, the GoTo my CrowdBoards functionality presents a summary of the following in the form of a Thermometer included within the CrowdBoard as further depicted in FIG. 2B: which displays the daily activity change in % percentage format, the amount left to fund to reach the fixed target in $ Dollars format and the current number of investors shown numerically as Boarders IN. Further background data and reporting is also accessible which shows the current Boarders IN details, the current value for the maximum number of Boarders IN, Trend reports of financial transactions associated with the CrowdBoard shown in time/date/daily/weekly/to date format and lastly the current funds raised in S Dollars format transposed into a % percentage of the overall Target fill for the Thermostat. With different colored fill applied at predetermined levels as shown on the thermostat glass which is a direct representation for the current % percentage of overall fixed target that has been reached since the CrowdBoard was made live.

Referring again to FIG. 1A, in Step 106 the CrowdBoarder has the option when they move onto the Investment set page to go public with their investment into a CrowdBoard or to keep it anonymous on their profile, the CrowdBoarders profile will show the specific CrowdBoard under their My investment Set once they add the CrowdBoard they invested in to their public profile. If they decide to keep their investment anonymous the only place it will show is on their own My Console under investment set.

Referring again to FIG. 1A, in Step 107, the CrowdBoarder on entry into their My Console will see any outstanding Border requests in red numerical figures contained in a bracket next to Boarder requests. The CrowdBoarder can then click on the Boarder request and it will take them to the selected Borders profile page, if the Add Boarder feature underneath the selected Boarders profile is further selected, their Profile picture will highlight green and if selected will be added to the CrowdBoarders current list of Boarders maintained in the Database. The full list of their Boarders Network can be also viewed by scrolling down the Boarder page.

Furthermore in Step 107. The CrowdBoarder has an additional feature Borders Lineup, which is primarily displayed within their My Console, this affords them the possibility of adding a total of 6 (six) other Boarders as part of their Lineup in addition to the CrowdBoarder, which can then be viewed by other Boarders who access their Profile. When the Add Boarder is offered, once selected it presents the option to the CrowdBoarder to add that Border to their current Lineup if chosen to share news, ideas and ultimately to join together in social investments.

Referring again to FIG. 1A, in Step 108, on arrival to My Console the CrowdBoarder has the option to view and select posted news items from Boarders within the Network. This feature CrowdNews contain all the generally available posts of interest to the CrowdBoarder selected via a relevance algorithm located in the Database pertaining to the Crowd Boarders known Border associated and CrowdBoards that the CrowdBoarder has actively posted on, liked or shared with their Boarder associates. Furthermore the CrowdBoarder has the option to message, comment, rate, like or share the news either on their profile or directly onto CrowdNews.

Referring again to FIG. 1A, in Step 109, the CrowdBoarder from My Console can directly access the Districts page, which houses all of the live. CrowdBoards by type of CrowdBoard related to the District distinction and can then select CrowdBoards of interest. Furthermore the CrowdBoarder has the feature to add their favorite Districts to their Profile for their personal display and also on their view profile for other Boarders to see. Furthermore the CrowdBoarder has the feature to search within the Districts for CrowdBoards from the My Console page.

Referring again to FIG. 1A, in Step 110 the CrowdBoarder can from My Console view latest Boards that have been created and placed live in District, with the relevance algorithm against presenting to them the new boards in Districts and the types of Board that they have shown previous interest in.

Finally referring to FIG, 1A, in Step 11 the CrowdBoarder has an advanced search feature that can be applied but not limited to: other Boarders, CrowdNews, Districts and Crowd Boards. The input to the search for Borders may include first and last name, a user name, a profession type, location of residence, location of hometown, birthdate, website, type of skills, descriptions of dreams, description of passions and description of possessions. The input to the search for CrowdNews may include, user name, type of CrowdBoard, name of CrowdBoard, Dates, comments, watches, ratings and investment types. The input to the search of Districts may include District names, CrowdBoard names, State of origin, type of CrowdBoard and statuses of CrowdBoards. The input to the search of CrowdBoards may include but not limited to, owners name, type of CrowdBoard, location of CrowdBoard, State of Origin, Video play, date created date funded, District location and current statuses of CrowdBoards.

Referring to FIG. 1B, this depicts the Network topology and the fact that all users regardless of user group designation or the activities they carry out on the Network are in essence the same a CrowdBoarder by nature.

A Project owner can create their own CrowdBoards and present theme live to seek investments using the Network as a Crowd Boarder.

A Crowdfunding platform owner can create multiple CrowdBoards that they can export/embed into 3rd Party external sites as well as post internally within the Network acting as a CrowdBoarder.

An Industry regulatory body such as the NLCFA or CAPS can utilize the Network for data and analytics provide by the Reporting module within the Database, which captures all transactions by individuals, Board performance and statistics to use for research and Industry report creation.

A Government regulatory body such as the SEC or FINRA can utilize the Network for live performance reporting within the Database, for trend analysis, unusual activity, funding metrics, alarm definition and settings, with access to a Government only reporting and alarm module while acting as a CrowdBoarder,

An actively licensed Fund Manager or Broker can utilize the Network for performance statistics and risk assessment within the Database, with access to a Manager/Broker only performance module while acting as a CrowdBoarder,

Any potential Investor accredited or non-accredited can make active investments and have access to all the CrowdBoards and their relevant data within the Network while acting as a Crowd Boarder.

A CrowdBoarder therefore by definition is an individual,company or body that actively utilizes the Social Investing Network (SIN) to carry out Crowdfunding related activities be it for seeking funds, social interaction, company gain, research, fund management or regulatory purposes

Referring to FIG. 2A, this depicts the complete process for creating a CrowdBoard of any type to go live on the Social Investing Network (SIN) that is subsequently then placed within the appropriate District or its content and then open for investments from other CrowdBoarders.

Referring again to FIG. 2A, in Step 1, the CrowdBoarders accesses the Network via theft own profile and selects the Create CrowdBoard feature from My Console.

Referring again to FIG. 2A in Step 2, once the Crowd Boarder has selected the Create CrowdBoard feature, this accesses the database, where the template for the CrowdBoard resides and presents the Create CrowdBoard page which details the steps to be taken for the creation.

Referring again to FIG. 2A in Step 3, the Crowd Boarder firstly selects the type of Board they want to create from the following 4 (four) options, Equity where the investor will receive a form of stake in the company in return for their investment, Reward where the investor receive a form of reward or perk, Charity where the investor effectively makes a donation to the Crowd Boarder for their chosen cause and lastly Debt where the investor receives a return of their capital lent in addition to an interest payment. Secondly the CrowdBoarder chooses the relevant District and Area the Board will be placed in and displayed in from the list of Districts such as but not limited to: Art, Business, Causes, Comics, Dance, Design, Fashion, Film & Video, Fitness, Food, Gaming, Green, Latino, Music, People, Photography, Publishing, Sports, Tech and Theater and furthermore into an Area subset of the District. Thirdly the CrowdBoarders inputs the relevant Board specifics such as but not limited to: Name of Board owner, Location, What target funds they are seeking, what they are offering in return for investments and a detailed description of the CrowdBoard. This description includes answers to the 4 (four) basic fundamentals questions associated with Crowd participation. 1. Why will people invest in the Board? 2. What is the appeal of the CrowdBoard? 3. What will you do with the funds raised? 4. How long will this take?. Lastly the Crowd Boarder can choose to enhance the display of their Board by selecting to upload the following but not limited to: Profile picture, Cover picture, Video and Background. The CrowdBoarder can also select a URL link within the CrowdBoarders site for external investors to view the Board, or to post the link on other 3^{rd} Party sites.

Referring again to FIG. 2A, In Step 4, the CrowdBoarder confirms their Fixed Financial Target (FFT) amount and then sets the number of variable levels of investment traditionally 3 (three). For each individual level the CrowdBoarder can then specify the Name of the level, the Description of the level and what is offered in return for an investment of that level. The CrowdBoarder also has a further option to raise the amount associated with that pre-determined level after a customizable number of investments or a customizable financial amount has already been reached.

Lastly Referring to FIG. 2A, in Step 5, once all the required details have been input by the Crowd Boarder, they then have the final option to either save the CrowdBoard as a draft to then activate it at a later date or to save and activate the CrowdBoard now. Once the CrowdBoard has been activated it is then live on the Network and viewable by all other Boarders, if draft is chosen it will be placed on the Owners profile where it will be viewable by other Boarders and will remain there indefinitely until the point where the CrowdBoarder chooses to activate it. Once a CrowdBoard has been made active in the Database it starts to collect analytical information on the Board activity and performance to be captured in the reporting module and presented as live statuses on the CrowdBoard display itself.

Referring to FIG. 2B, this illustrates a rendition of the graphic presentation of the CrowdBoard once it is activated and live on the Network, containing all of the relevant details and descriptions associated with the Board creation. The thermostat presentation of the live status of the CrowdBoard is also shown including daily activity, target funds left to raise, number of current investors depicted as Boarders IN further shown are the options for social interaction with reference to the specific Board such as but not limited to, watch, rate, like, comment and view.

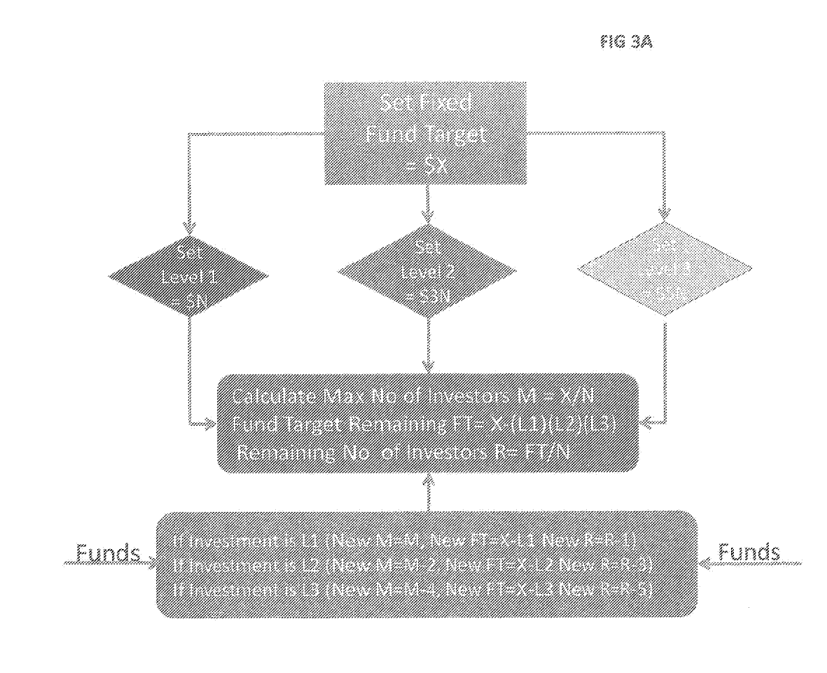

Referring to FIG. 3A, this depicts the methodology and mathematical calculations to support the claim for Fixed Target Variable Level Crowdfunding (FTVLC) for a CrowdBoard, wherein the first step is to set the fixed target for funding (FFT) as a $ Dollar figure (X), the second step is to set the traditional 3 (three) levels of funding in $ Dollar figures (L1, L2 and L3). Once these have been determined firstly the maximum number of investors (M) can be calculated by dividing the Target dollar number (X) by the dollar number associated with the lowest predetermined investment level (N) or (L1). Furthermore in line with the variance achieved once investments take place with the CrowdBoard, the Fund Target remaining (FT) can also be calculated at any instance by taking the Fixed Target amount (X) and subtracting the $ Dollar total amount invested in all of the 3 (three) pre-determined set investment levels (L1, L2, L3) by adding the amount together. The remaining number of investors (R) required to meet the Financial target can then also be calculated at any instance by taking the Fund Target remaining dollar amount (FT) and dividing it by the dollar amount associated with the lowest predetermined investment level (N) or (L1). Once the CrowdBoard is live and receiving investments from other CrowdBoarders, the Maximum number of Investors (M), the funds target remaining (FT) and the remaining number of investors to achieve the target goal (R) will also subsequently vary in accordance with the level of investments and the financial figures associated with that corresponding level and can therefore be calculated at any instance by the mathematical calculations as shown in FIG. 3A.

Under the Securities Act of 1933, any CrowdBoarder company that offers or sells its securities has to register those securities with the SEC or seek an exemption from the registration requirements. Any potential sale of securities is deemed as an active offer. The Act does however provides companies with a number of exemptions. Current known exemptions are shown under rules 505 and 506 of Regulation D; whereas a CrowdBoarder registered company may offer its securities to individuals that are classified “accredited investors.” The federal securities laws furthermore define the qualification criteria necessary for accredited investor status.

Accredited individuals are given the opportunity on registration with Crowd Boarders to declare the fact that they are already accredited, which will then display their accredited status in the Network but only for administrative personnel to view. When they make an investment into a CrowdBoard, in the investor report compiled for the owner, accredited investors will be denoted with an asterixistar next to their name to highlight theft pre-qualified accredited status.

While the invention has been illustrated and described in detail including the methodology and activities involved with the Social Investment Network (SIN) and user created CrowdBoards. The various embodiments shown and furthermore described in detail are not intended to be limiting to the future expansion of details shown, since various modifications and structural changes may be made in the future without being detrimental or leading to a different direction in any way from the foundations and principles of the present invention. The embodiments currently chosen and described in detail were made in the context of explaining and understanding of the foundations and principles associated with the invention and subsequent application to hereby enable a person skilled in the Crowdfunding industry to best utilize and apply the invention in pursuit of social business and investments. The present invention while for the Crowdfunding audience is categorized in a different way from the generic platforms that exist today, due to the primary focus being one of social interaction, the introduction of a specific mechanism or vessel in the way of a CrowdBoard and furthermore the invention and application of Fixed Target Variable Level Crowdfunding (FTVLC) to greatly improve the probability of a CrowdBoard raisings its full financial target in comparison to the existing Crowdfunding methodologies wherein full funding occurs in less than half of all current cases recorded in the Industry today.

1. A computer based Internet Website “Crowd Boarders” that provides a single point user access to the Network for social interaction and financial investments using an Internet interface, comprising a computer processor, software applications to performing a variety of functions, a connected database for storing data, means for inputting data to the database using data storage criteria, and a connected Internet application interface to allow a user access to data including listings of CrowdBoards on the website by District and Area allocation criteria. Other user (CrowdBoarder) profile information and their own profile information via My Console complete with a unique Boarder I.D number for identification purposes. The single point user access also provides full access to the Crowd Boarders personal social activity capabilities.

2. Wherein the website is accessible by a mobile device or a personal computer.

3. Wherein application interface allows a CrowdBoarder to enter the website and access data by logging onto the website by inputting a CrowdBoarder identification user name and password, and to upload these for storage in the database and build a CrowdBoarder profile for reference purposes.

4. Wherein the user groups designated for access to the single point user interface are classified as one of the following Crowd Boarder, Platform Owner, Broker and Regulator based on their profile registration.

5. Wherein Crowd Boards consist of specific data that can be deemed classified as Crowdfunding Boards by nature

6. Wherein financial investments that are carried out on a CrowdBoard are fundamentally Crowdfunding Investments by nature.

7. Wherein Investors in a CrowdBoard can include other CrowdBoarders, Brokers, Platform Owners, Industry and Government Regulators.

8. Wherein the software applications includes a program allowing a Crowd Board owner to connect through their Network and to interact with previously identified CrowdBoarders that have directly invested in their personal Crowd Board.

9. Wherein the single point user access is accessible by the CrowdBoarder and also associates that can be accepted by the CrowdBoarder and subsequently added to their respective Boarders Lineup if applicable and also allowing the CrowdBoarder to effectively manage their own selected Boarders Network.

10. Further contains a search engine, wherein the CrowdBoarder can control information available to other CrowdBoarders search requests and also allows the CrowdBoarder to search all CrowdBoards in all designated Districts in pursuit of social interaction and investment.

11. Wherein the single point user access containing the individual CrowdBoarders information is presented in a Console format and allows the CrowdBoarder to create and edit their profile information for other Boarders viewing and also to see and control their own postings to only allow certain designated posting's to be accessible on the Network. The personal interactions and details can include access messages, access notifications, create post, create CrowdBoard, create Investment set, edit/view profile, and upload pictures and video. Change Boarders Lineup, Add Boarder and message Boarders are also provided and the accessibility to their information derived from the individual's postings, other CrowdBoarder campaigns and retrieval site information from other Crowd Boarders will also be offered.

12. Wherein the single point user access has CrowdBoarders activity and status viewable: including personal details, posts, comments, investments, news, CrowdBoards created, watched CrowdBoards, districts, possessions, photos, videos, Boarders lineup and investment set.

13. Further contains a CrowdBoard database wherein the Boarder can search for a CrowdBoard, create a CrowdBoard, request additional information on a Board, watch a Board, rate a Board, comment on a Board and subsequently invest in a CrowdBoard.

14. Further comprising a database that captures individual CrowdBoarder and collective CrowdBoards financial transactions for collaboration and presentation in report format for local analysis, SEC submission and alarm generation if designated conforming or non-conforming to legislation requirement criteria,

15. Wherein software applications includes an algorithm allowing a CrowdBoarder to search the database by criteria for presentation of potential Crowd Boards for investment that are best suited to their personal taste or are owned by Boarders with a direct social relationship to them in the Social Investing Network.

16. Wherein the purpose built CrowdBoard will be created and then placed into one of the newly defined active Districts, this District and Area design concept is entirely new for the Crowdfunding Industry, these Districts and Areas will reside within the Social Investing Network and will comprise firstly of the following 20 (Twenty) Districts but not limited to: Art, Business, Causes, Comics, Dance, Design, Fashion, Films & Video, Fitness, Food, Gaming, Green, Latino, Music, People, Photography, Publishing, Sports, Tech and Theater. Dependent on the best fit based on the individual CrowdBoard design and content. Furthermore each District will comprise of a secondary level named Areas, which have been identified to further associate the type of CrowdBoard to a known genre or subset of the relevant District's description. There may be 10 (ten) or more defined Areas within a District. In the case of say the Films & Video District, these areas would specifically be named as the following subsets (Action, Adventure, Comedy, Documentary, Drama, Epic/Historical, Foreign, Horror, Music/Dance and Science Fiction),

17. Wherein further comprising computer software allowingg CrowdBoard to be exported and listed on third party external websites.

18. Further comprising computer software to permit data capture, conducting analytics and presentation of data within a CrowdBoard model comprising of the following data collection designation on a daily basis, Board ratings, Board watches, Board comments and number of investments. Data is collated and presented in the form of a graphic Thermostat showing daily activity change in %, amount left to fund in $ and current number of investors (Boarders In), the amount left is a constant changing target based on the specific Investor levels for the remaining amount so days are not portrayed as it utilizes the 3 step investment level Fixed Target Variable Level Crowdfunding (FTVLC) methodology.

19. A method for social interaction and networking, this methodology comprising: a CrowdBoarder single login function to connect the CrowdBoarder to a Crowd Boarding specific Network wherein the CrowdBoarder can create a profile, view other profiles, search for like-minded individuals and actively participate in creating CrowdBoards share information and knowledge. Search active CrowdBoards for CrowdBoarder created content and search for statistics and performance of CrowdBoards within specific Districts and Areas located within a Social Investing Network including investments into applicable CrowdBoards.

20. Wherein searches include searches on external websites for listings of financial investments at any sites or investments in currently active CrowdBoards.

21. Wherein searches include searches for investment history or CrowdBoards similar to the current CrowdBoard in which a CrowdBoarder is considering an investment or in which a CrowdBoard owner deliberates activating their Board in a specific district.

22. Wherein searches include searches for potential CrowdBoards of interest in any operational districts within the Social Investing Network.

23. Wherein created CrowdBoard shows details of the Board including purpose, a description of the need, appeal of Board, a declaration of proposed uses of funds after raise, type of rewards to the Investors, predicted length of time to raise the funds, identity of CrowdBoard owner and investor tracking.

24. Wherein the software application contains a specific program for measuring success indicators for a particular CrowdBoard based on the individual Crowd Boards details and incorporating the use of standard evaluation metrics historically developed.

25. Wherein the software application includes a program for carrying out valuation calculations for a particular CrowdBoard based on CrowdBoard content, target and area of operations utilizing standard valuation metrics gathered from CrowdBoard performance historical data.

26. Wherein the CrowdBoard owner sets a fixed Target for the monies to be raised and then sets primarily 3 (three) or secondary another number of different levels of investments, so the maximum number of Investors varies in accordance with actual investment levels to encourage active participation from other Crowd Boarders.
